(19) United States
(12) Patent Application Publication
(10) Pub. No.: US 2013/0120307 A1
(43) Pub. Date: May 16, 2013

(54) Handheld Device and Control Method Thereof

(71) Applicants: Ya-Ting Tsai, Sanchong City (TW); Jia-Shen Hua, Tainan City (TW); Chun-Ming Wang, Taipei City (TW); Chien-Hsiung Chen, Taipei City (TW)

(72) Inventors: Ya-Ting Tsai, Sanchong City (TW); Jia-Shen Hua, Tainan City (TW); Chun-Ming Wang, Taipei City (TW); Chien-Hsiung Chen, Taipei City (TW)

(73) Assignee: INSTITUTE FOR INFORMATION INDUSTRY, Taipei (TW)

(21) Appl. No.: 13/314,331

(22) Filed: Dec. 8, 2011

(30) Foreign Application Priority Data
Nov. 11, 2011 (TW) 100141280

(51) Int. Cl. G06F 3/041; G06F 3/045

(52) U.S. Cl. 345/174; 345/173

(57) ABSTRACT

A handheld device includes a touch panel, a speaker, and a processor. The touch panel is operable to detect the touched area generated by an object touching the touch panel. The speaker is operable to provide sounds. The processor is connected to the touch panel and the speaker and controls the volume of the sounds provided by the speaker based on the touched area. The processor decreases the volume of the sounds when the value of the touched area is lower than a first predetermined value, and the processor increases the volume of the sounds when the value of the touched area is high than a second predetermined value. Furthermore, a method for controlling the handheld device is disclosed herein.

### RELATED APPLICATIONS

This application claims priority to Taiwan Application Serial Number 100141280, filed Nov. 11, 2011, which is herein incorporated by reference.

### BACKGROUND

1. Field of Invention

The embodiment of the present invention relates generally to an electrical communication device and, more particularly, to a handheld device.

2. Description of Related Art

The conventional way to adjust a microphone of a handheld device is to is adjust the volume of sounds provided by the handheld device based on requirements of a user. To accomplish the above-mentioned adjusting mode, there is usually a button disposed on the lateral side of the handheld device so that the user can use the button to adjust the volume of sounds provided by the handheld device based on the environmental condition during communication.

However, the above-mentioned adjusting mode is not instinctive, and the user has to learn the adjusting mode for adjusting the volume of sounds provided by the handheld device. Furthermore, the above-mentioned adjusting mode is not convenient, because the user has to use the button disposed on the lateral side of the handheld device to adjust the volume of sounds by hand.

In summary, the existing apparatus and techniques still have obvious defects and need further improvement. In order to solve the above problems, those skilled in the art are trying hard to find a solution, but no suitable method has been proposed.

### SUMMARY

A handheld device, which addresses the problem of adjusting mode of a conventional handheld device being not instinctive due to the adjusting mode of volume of sounds needed to be learned, and which addresses the problem of the adjusting mode of a conventional handheld device being not convenient due to a user having to use the button disposed on the lateral side of the handheld device to adjust the volume of sounds by hand.

Thus, one aspect of the embodiment of the present invention is to provide a handheld device. The handheld device comprises a touch panel, a speaker, and a processor. The touch panel detects a touched area generated by an object touching the touch panel. The speaker provides sounds. The processor is electrically connected to the touch panel and the speaker, and the processor controls the volume of the sounds provided by the speaker based on the touched area. The processor decreases the volume of the sounds provided by the speaker when the value of the touched area is lower than a first predetermined value, and the processor increases the volume of the sounds provided by the speaker when the value of the touched area is higher than a second predetermined value.

In one embodiment of the present invention, the handheld device further comprises a pressure sensor. The pressure sensor senses a pressure generated by the object pressing the handheld device. The processor is electrically connected to the pressure sensor, and the processor controls the volume of the sounds provided by the speaker based on the pressure. The processor increases the volume of the sounds provided by the speaker when the value of the pressure is higher than a third predetermined value.

In another embodiment of the present invention, the pressure sensor is activated when the value of the touched area is steady; meanwhile, the processor controls the volume of the sounds provided by the speaker based on the pressure.

In yet another embodiment of the present invention, the touch panel comprises at least one of a resistive touch panel and a capacitive touch panel.

In still another embodiment of the present invention, the touch panel detects the touched area generated by the object touching the touch panel every constant time interval. The touched area detected at the beginning of the constant time interval is a first touched area, and the touched area detected at the end of the constant time interval is a second touched area. The processor increases the volume of the sounds provided by the speaker when the difference between the second touched area and the first touched area is higher than a range, and the processor decreases the volume of the sounds provided by the speaker when the difference between the second touched area and the first touched area is lower than the negative range.

In yet another embodiment of the present invention, the pressure sensor senses the pressure generated by the object pressing the handheld device every constant time interval. The pressure sensed at the beginning of the constant time interval is a first pressure, and the pressure sensed at the end of the constant time interval is the second pressure. The processor increases the volume of the sounds provided by the speaker when the difference between the second pressure and the first pressure is higher than a range, and the processor decreases the volume of the sounds provided by the speaker when the difference between the second pressure and the first pressure is lower than the negative range.

In still another embodiment of the present invention, the handheld device further comprises a memory. The memory stores the volume of the sounds provided by the speaker.

In yet another aspect of the embodiment of the present invention, a method for controlling a handheld device is provided. The method for controlling a handheld device comprises the steps of detecting a touched area generated by an object touching a touch panel; determining whether the value of the touched area is lower than a first predetermined value, if it being determined that the value of the touched area is lower than the first predetermined value, decreasing a volume of sounds provided by a speaker; and determining whether the value of the touched area is higher a second predetermined value, if it being determined that the value of the touched area is higher than the second predetermined value, increasing the volume of the sounds provided by the speaker.

In one embodiment of the present invention, the method for controlling the handheld device further comprises the steps of sensing a pressure generated by the object pressing the handheld device; and determining whether the value of the pressure is higher than a third predetermined value, if it being determined that the value of the pressure is higher than the third predetermined value, increasing the volume of the sounds provided by the speaker.

In another embodiment of the present invention, the step of sensing the pressure generated by the object pressing the handheld device is implemented is after the value of the touched area is steady.

In yet another embodiment of the present invention, the step of detecting the touched area generated by the object touching the touch panel is implemented every constant time interval. The touched area detected at the beginning of the constant time interval is a first touched area, and the touched area detected at the end of the constant time interval is a second touched area. The volume of the sounds provided by the speaker is increased when the difference between the second touched area and the first touched area is higher than a range, and the volume of the sounds provided by the speaker is decreased when the difference between the second touched area and the first touched area is lower than the negative range.

In still another embodiment of the present invention, the step of sensing the pressure generated by the object pressing the handheld device is implemented every constant time interval. The pressure sensed at the beginning of the constant time interval is a first pressure, and the pressure sensed at the end of the constant time interval is a second pressure. The volume of the sounds provided by the speaker is increased when the difference between the second pressure and the first pressure is higher than a range, and the volume of the sounds provided by the speaker is decreased when the difference between the second pressure and the first pressure is lower than the negative range.

In yet another embodiment of the present invention, before the step of detecting the touched area generated by the object touching the touch panel, the method for controlling the handheld device further comprises the step of generating an initial volume of the sounds by the speaker.

In still another embodiment of the present invention, after the step of decreasing the volume of the sounds provided by the speaker or increasing the volume of the sounds provided by the speaker, the method for controlling the handheld device further comprises the step of storing the volume of the sounds provided by the speaker as the initial volume of the sounds.

In summary, the embodiments of the present invention provide a handheld device and a method for controlling thereof are provided, which addresses the problem of adjusting mode of a conventional handheld device being not instinctive due to the adjusting mode of volume of sounds needed to be learned, and which addresses the problem of the adjusting mode of a conventional handheld device being not convenient due to a user having to use the button disposed on the lateral side of the handheld device to adjust the volume of sounds by hand.

### BRIEF DESCRIPTION OF THE DRAWINGS

The invention can be more fully understood by reading the following detailed description of the embodiments, with reference made to the accompanying drawings as follows:

FIG. 1 schematically shows a circuit block diagram of a handheld device according to embodiments of the present invention.

FIG. 2 schematically shows a diagram of actual operating mode of a handheld device according to embodiments of the present invention.

FIG. 3 schematically shows a diagram of actual operating mode of a handheld device according to embodiments of the present invention.

FIG. 4 schematically shows a diagram of an area range contrast table of a handheld device according to embodiments of the present invention.

FIG. 5 schematically shows a diagram of a pressure range contrast table of a handheld device according to embodiments of the present invention.

FIG. 6 schematically shows a waveform diagram of a method for controlling a handheld device according to embodiments of the present invention.

FIG. 7 schematically shows a waveform diagram of a method for controlling a handheld device according to embodiments of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean is including but not limited to.

FIG. 1 schematically shows a circuit block diagram of a handheld device 100 according to embodiments of the present invention. As shown in FIG. 1, the handheld device 100 comprises a touch panel 110, a speaker 130, and a processor 120. The touch panel 110 detects a touched area generated by an object touching the touch panel 110. The speaker 130 provides sounds. The processor 120 is electrically connected to the touch panel 110 and the speaker 130 and controls the volume of the sounds provided by the speaker 130 based on the touched area.

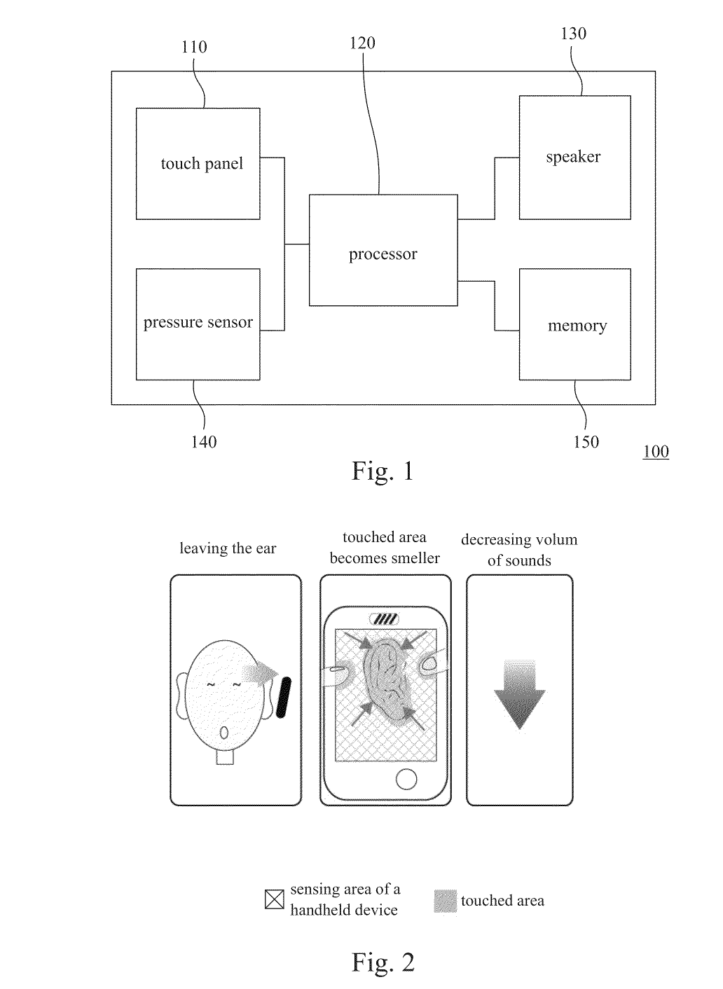

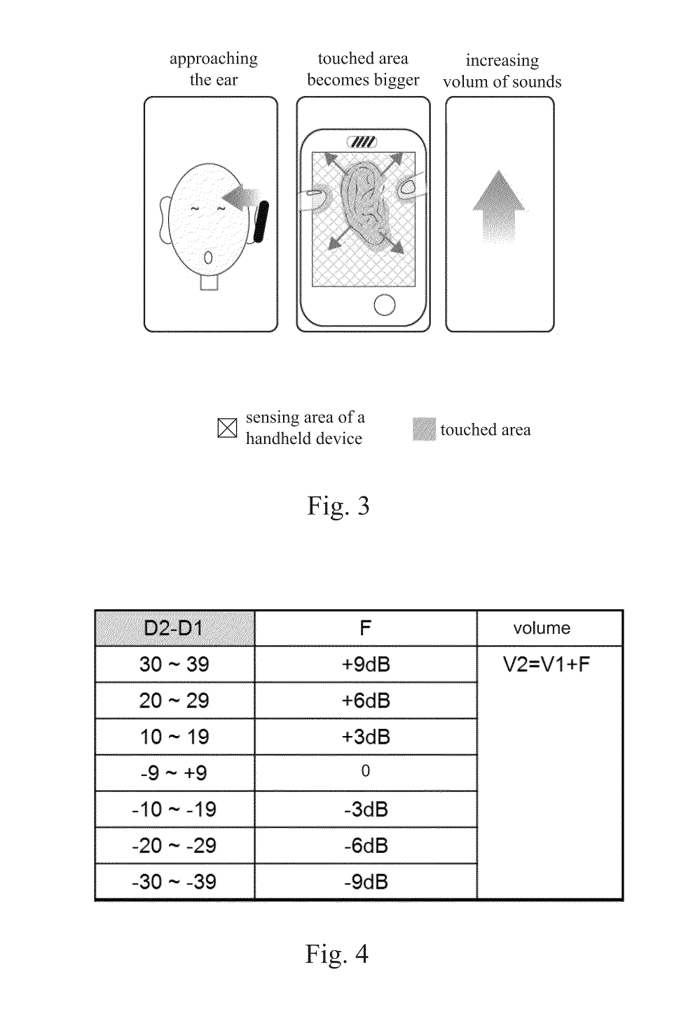

The control mode of the volume of the sounds provided by the speaker 130 of the embodiment of the present invention is described with FIG. 2 and FIG. 3. FIG. 2 schematically shows a diagram of actual operating mode of a handheld device 100 according to embodiments of the present invention, and FIG. 3 schematically shows a diagram of actual operating mode of a handheld device 100 according to embodiments of the present invention.

Reference is now made to FIG. 2. We assume that initial volume of sounds provided by the speaker 130 is high so that the user is uncomfortable. Meanwhile, the user will move the handheld device 100 away from the face of the user such that the touched area generated by ear, face, or finger of the user touching the touch panel 110 becomes smeller. The processor 120 decreases the volume of the sounds provided by the speaker 130 when the value of the touched area is lower than a first predetermined value such that the user can hear the sounds provided by the speaker 130 comfortably.

The first predetermined value can be set based on actual requirements. For example, the first predetermined value can be 15 squire centimeters. The processor 120 decreases the volume of the sounds provided by the speaker 130 when the value of the touched area is lower than 15 squire centimeters. However, the present invention is not limited in this regard, and those skilled in the art can selectively adopt appropriate value as the first predetermined value, depending on actual requirements.

Next, referring to FIG. 3, we assume that initial volume of sounds provided by the speaker 130 is smell such that the user cannot hear the volume of the sounds provided by the speaker 130 clearly. Meanwhile, the user will move the handheld device 100 near the face of the user such that the touched area generated by ear, face, or finger of the user touching the touch panel 110 becomes bigger. The processor 120 increases the volume of the sounds provided by the speaker 130 when the value of the touched area is higher than a second predetermined value such that the user can hear the sounds provided by the speaker 130 clearly.

The second predetermined value can be set based on actual requirements. For example, the second predetermined value can be 20 squire centimeters. The processor 120 increases the volume of the sounds provided by the speaker 130 when the value of the touched area is higher than 20 squire centimeters. However, the present invention is not limited in this regard, and those skilled in the art can selectively adopt appropriate value as the second predetermined value, depending on actual requirements.

In one embodiment of the present invention, the user attaches his/her ear, face, and finger to the handheld device 100 completely when the volume of the sounds provided by the speaker 130 is smell. In this condition, the touched area generated by the ear, the face, and the finger of the user touching the touch panel 110 is steady, and the volume of the sounds provided by the speaker 130 cannot be increased by the increasing of the touched area. Thus the handheld device 100 can further comprise a pressure sensor 140 to solve the above-mentioned problem.

As mentioned above, the pressure sensor 140 is activated when the value of the touched area is steady. Meanwhile, the pressure sensor 140 senses the pressure generated by the object pressing the handheld device 100. The processor 120 is electrically connected to the pressure sensor 140, and the processor 120 controls the volume of the sounds provided by the speaker 130 based on the pressure. The processor 120 increases the volume of the sounds provided by the speaker 130 when the value of the pressure is higher than a third predetermined value. The third predetermined value can be set based on actual requirements.

In manufacturing, the touch panel 110 comprises at least one of a resistive touch panel and a capacitive touch panel, that is to say, the touch panel 110 can be a resistive touch panel or a capacitive touch panel. However, the present invention is not limited in this regard, and those skilled in the art can selectively adopt appropriate electrical element to detect the touched area, depending on actual requirements.

FIG. 4 schematically shows a diagram of an area range contrast table of a handheld device 100 according to embodiments of the present invention. In the embodiment of the present invention, the touch panel 110 detects the touched area generated by the object touching the touch panel 110 every constant time interval. The touched area detected at the beginning of the constant time interval is a first touched area (D1), and the touched area detected at the end of the constant time interval is a second touched area (D2). The constant time interval can be set based on actual requirements, for instant, but not limited to 500 milliseconds. The processor 120 adjusts the volume of the sounds provided by the speaker 130 based on the touched area variation (D2−D1), and the formula is as follow:

$$F = \frac{( D 2 - D 1 )}{L 1} \times 3 ;$$

F is the value of the volume of the sounds needed to be adjusted, L1 is the first level range, D1 is the first touched area, and D2 is the second touched area. The predetermined value of L1 is 10. As shown in FIG. 4, V2 is the adjusted volume of the sounds, that is say, the present volume of the sounds. V2 is generated by adding F acquired by the formula to V1 (initial volume).

For example, the processor 120 increases the value of the volume of the sounds provided by the speaker 130 3 dB when the difference between the second touched area and the first touched area (D2−D1) is in the first interval (10˜19); the processor 120 increases the value of the volume of the sounds provided by the speaker 130 6 dB when the difference (D2−D1) is in the second interval (20˜29); the processor 120 increases the value of the volume of the sounds provided by the speaker 130 9 dB when the difference (D2−D1) is in the third interval (30˜39), and so on. Moreover, the processor 120 does not adjust the value of the volume of the sounds provided by the speaker 130 when the difference (D2−D1) is in the middle interval (−9˜+9).

In addition, the processor 120 decreases the value of the volume of the sounds provided by the speaker 130 3 dB when the difference between the second touched area and the first touched area (D2−D1) is in the fourth interval (−10˜−19); the processor 120 decreases the value of the volume of the sounds provided by the speaker 130 6 dB when the difference (D2−D1) is in the fifth interval (−20˜29); the processor 120 decreases the value of the volume of the sounds provided by the speaker 130 9 dB when the difference (D2−D1) is in the sixth interval (−30˜−39), and so on. However, the present invention is not limited in this regard.

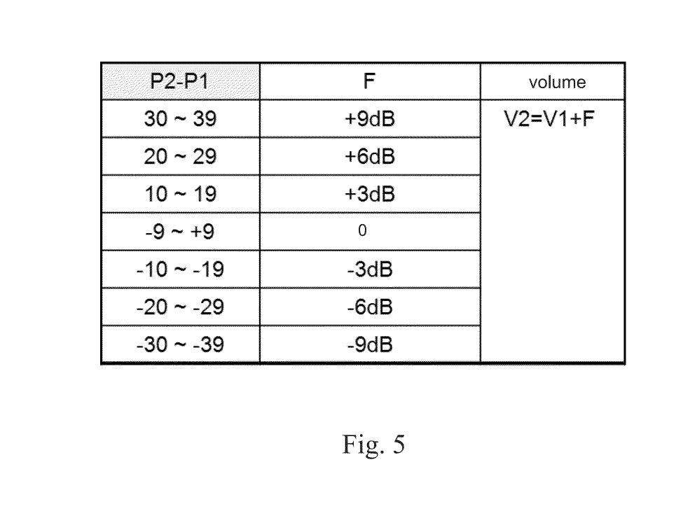

FIG. 5 schematically shows a diagram of a pressure range contrast table of a handheld device 100 according to embodiments of the present invention. In the embodiment of the present invention, the pressure sensor 140 senses a pressure generated by the object pressing the handheld device 100 every constant time interval. The pressure sensed at the beginning of the constant time interval is a first pressure (P1), and the pressure sensed at the end of the constant time interval is the second pressure (P2). The constant time interval can be set based on actual requirements, for instant, but not limited to 500 milliseconds. The processor 120 adjusts the volume of the sounds provided by the speaker based on the pressure variation (P2−P1), and the formula is as follow:

$$F = \frac{( P 2 - P 1 )}{L 2} \times 3 ;$$

F is the value of the volume of the sounds needed to be adjusted, L2 is the second level range, P1 is the first pressure, and P2 is the second pressure. The predetermined value of L2 is 10. As shown in FIG. 5, V2 is the adjusted volume of the sounds, that is to say, the present volume of the sounds. V2 is generated by adding F acquired by the formula to V1 (initial volume).

For example, the processor 120 increases the value of the volume of the sounds provided by the speaker 130 3 dB when the difference between the second pressure and the first pressure (P2−P1) is in the first interval (10˜19); the processor 120 increases the value of the volume of the sounds provided by the speaker 130 6 dB when the difference (P2−P1) is in the second interval (20˜29); the processor 120 increases the value of the volume of the sounds provided by the speaker 130 9 dB when the difference (P2−P1) is in the third interval (30˜39), and so on. Moreover, the processor 120 does not adjust the value of the volume of the sounds provided by the speaker 130 when the difference (P2−P1) is in the middle interval (−9˜+9).

In addition, the processor 120 decreases the value of the volume of the sounds provided by the speaker 130 3 dB when the difference between the second pressure and the first pressure (P2−P1) is in the fourth interval (−10˜−19); the processor 120 decreases the value of the volume of the sounds provided by the speaker 130 6 dB when the difference (P2−P1) is in the fifth interval (−20˜−29); the processor 120 decreases the value of the volume of the sounds provided by the speaker 130 9 dB when the difference (P2−P1) is in the sixth interval (−30˜−39), and so on. However, the present invention is not limited in this regard.

As shown in FIG. 1, the handheld device 100 further comprises a memory 150. The memory 150 stores the value of the volume of the sounds provided by the speaker 130 at every end of the constant time interval and stores the value of the volume of the sounds provided by the speaker 130 when the user finishes using the handheld device 100. The handheld device 100 can use an appropriate value of the volume of the sounds next time the user uses the handheld device 100 so that the user can communicate with others by the handheld device 100 comfortably.

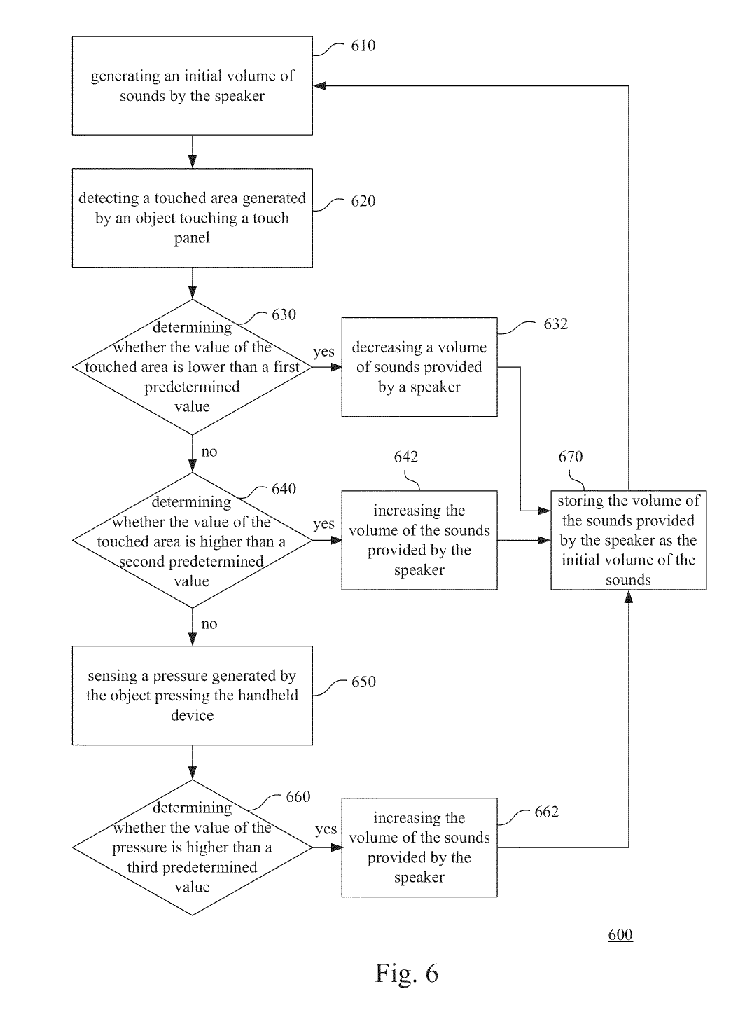

FIG. 6 schematically shows a waveform diagram of a method 600 for controlling a handheld device according to embodiments of the present invention. Reference is now made to both FIG. 1 and FIG. 6, the method 600 for controlling the handheld device 100 comprises the steps of generating an initial volume of sounds by the speaker 130 (step 610); detecting a touched area generated by an object touching a touch panel 110 (step 620); determining whether the value of the touched area is lower than a first predetermined value (step 630), if it being determined that the value of the touched area is lower than the first predetermined value, decreasing a volume of sounds provided by a speaker 130 (step 632); determining whether the value of the touched area is higher than a second predetermined value (step 640), if it being determined that the value of the touched area is higher than the second predetermined value, increasing the volume of the sounds provided by the speaker 130 (step 642).

Reference is now made to both FIG. 1 and FIG. 6. In step 610, first, the speaker 130 is implemented to generate the initial volume of the sounds. The initial volume of the sounds can be the volume of the sounds provided by the speaker 130 stored at last time the user finishing using the handheld device 100. As mentioned above, the user can use the handheld device 100 to hear the sounds provided by the speaker 130 comfortably at this time if the environmental condition this time is similar to the environmental condition last time the user using the handheld device 100.

In step 620, the touch panel 110 can be implemented to detect the touched area generated by the object touching the touch panel 110. Then, the processor 120 can be implemented to determine whether the value of the touched area is lower than the first predetermined value in step 630. If it is determined that the value of the touched area is lower than the first predetermined value, the step 632 is implemented to decrease the volume of the sounds provided by the speaker 130. The description of the related environmental condition refers to the description of FIG. 2. Hence, the user can hear the sounds provided by the speaker 130 comfortably.

The first predetermined value can be set based on actual requirements. For example, the first predetermined value can be 15 squire centimeters. The processor 120 decreases the volume of the sounds provided by the speaker 130 when the value of the touched area is lower than 15 squire centimeters. However, the present invention is not limited in this regard, and those skilled in the art can selectively adopt appropriate value as the first predetermined value, depending on actual requirements.

Referring to step 640, the processor 120 can be implemented to determine whether the value of the touched area is higher than the second predetermined value. If it is determined that the value of the touched area is higher than the second predetermined value, the step 642 is implemented to increase the volume of the sounds provided by the speaker 130. The description of the related environmental condition refers to the description of FIG. 3. Hence, the user can hear the sounds provided by the speaker 130 comfortably.

The second predetermined value can be set based on actual requirements. For example, the second predetermined value can be 20 squire centimeters. The processor 120 increases the volume of the sounds provided by the speaker 130 when the value of the touched area is higher than 20 squire centimeters. However, the present invention is not limited in this regard, and those skilled in the art can selectively adopt appropriate value as the second predetermined value, depending on actual requirements.

In one embodiment of the present invention, as shown in FIG. 4, the step of detecting the touched area generated by the object touching the touch panel 110 is implemented every constant time interval. The touched area detected at the beginning of the constant time interval is a first touched area (D1), and the touched area detected at the end of the constant time interval is a second touched area (D2). The processor 120 adjusts the volume of the sounds provided by the speaker 130 based on the touched area variation (D2−D1), and the formula is as follow:

$$F = \frac{( D 2 - D 1 )}{L 1} \times 3 ;$$

The meanings of the symbols are mentioned in the description of FIG. 4, and accordingly, a detailed description regarding the meanings of the symbols are omitted herein for the sake of brevity. The processor 120 increases the value of the volume of the sounds provided by the speaker 130 3 dB when the difference between the second touched area and the first touched area (D2−D1) is in the first interval (10˜19); the processor 120 increases the value of the volume of the sounds provided by the speaker 130 6 dB when the difference (D2−D1) is in the second interval (20˜29); the processor 120 increases the value of the volume of the sounds provided by the speaker 130 9 dB when the is difference (D2−D1) is in the third interval (30˜39), and so on. Moreover, the processor 120 does not adjust the value of the volume of the sounds provided by the speaker 130 when the difference (D2−D1) is in the middle interval (−9˜+9).

In addition, the processor 120 decreases the value of the volume of the sounds provided by the speaker 130 3 dB when the difference between the second touched area and the first touched area (D2−D1) is in the fourth interval (−10˜−19); the processor 120 decreases the value of the volume of the sounds provided by the speaker 130 6 dB when the difference (D2−D1) is in the fifth interval (−20˜−29); the processor 120 decreases the value of the volume of the sounds provided by the speaker 130 9 dB when the difference (D2−D1) is in the sixth interval (−30˜−39), and so on. However, the present invention is not limited in this regard.

In another embodiment of the present invention, the method 600 for controlling the handheld device 100 further comprises the steps of sensing a pressure generated by the object pressing the handheld device (step 650); determining whether the value of the pressure is higher than a third predetermined value (step 660), if it being determined that the value of the pressure is higher than the third predetermined value, increasing the volume of the sounds provided by the speaker 130 (step 662); and storing the volume of the sounds provided by the speaker 130 as the initial volume of the sounds (step 670).

In step 650, the pressure sensor 140 can be implemented to sense the pressure generated by the object pressing the handheld device 100. Then, in step 660, the processor 120 can be implemented to determine whether the value of the pressure is higher than the third predetermined value. If it is determined that the value of the pressure is higher than the third predetermined value, the step 662 can be implemented to increase the volume of the sounds provided by the speaker 130.

In one embodiment of the present invention, the user attaches his/her ear, face, and finger to the handheld device 100 completely when the volume of the sounds provided by the speaker 130 is smeller. In this condition, the touched area generated by the ear, the face, and the finger of the user touching the touch panel 110 is steady, and the volume of the sounds provided by the speaker 130 cannot be increased by the increasing of the touched area. Thus the above-mentioned problem can be solved by sensing a pressure generated by the ear, the face, and the finger of the user touching the handheld device 100.

As mentioned above, the step of sensing the pressure generated by the object pressing the handheld device 100 is implemented when the value of the touched area is steady. The processor 120 is implemented to increase the volume of the sounds provided by the speaker 130 when the value of the pressure is higher than the third predetermined value. The third predetermined value can be set based on actual requirements.

In still another embodiment of the present invention, as shown in FIG. 5, the step of sensing the pressure generated by the object pressing the handheld device 100 is implemented every constant time interval. The pressure sensed at the beginning of the constant time interval is a first pressure (P1), and the pressure sensed at the end of the constant time interval is the second pressure (P2). The constant time interval can be set based on actual requirements. The processor 120 adjusts the volume of the sounds provided by the speaker based on the pressure variation (P2−P1), and the formula is as follow:

$$F = \frac{( P 2 - P 1 )}{L 2} \times 3 ;$$

The meanings of the symbols are mentioned in the description of FIG. 5, and accordingly, a detailed description regarding the meanings of the symbols are omitted herein for the sake of brevity. The processor 120 increases the value of the volume of the sounds provided by the speaker 130 3 dB when the difference between the second pressure and the first pressure (P2−P1) is in the first interval (10˜19); the processor 120 increases the value of the volume of the sounds provided by the speaker 130 6 dB when the difference (P2−P1) is in the second interval (20˜29); the processor 120 increases the value of the volume of the sounds provided by the speaker 130 9 dB when the difference (P2−P1) is in the third interval (30˜39), and so on. Moreover, the processor 120 does not adjust the value of the volume of the sounds provided by the speaker 130 when the difference (P2−P1) is in the middle interval (−9˜+9).

In addition, the processor 120 decreases the value of the volume of the sounds provided by the speaker 130 3 dB when the difference between the second pressure and the first pressure (P2−P1) is in the fourth interval (−10˜−19); the processor 120 decreases the value of the volume of the sounds provided by the speaker 130 6 dB when the difference (P2−P1) is in the fifth interval (−20˜−29); the processor 120 decreases the value of the volume of the sounds provided by the speaker 130 9 dB when the difference (P2−P1) is in the sixth interval (−30˜−39), and so on. However, the present invention is not limited in this regard.

In step 670, the memory 150 can be implemented to store the value of the volume of the sounds provided by the speaker 130 as the initial volume of the sounds. The memory 150 stores the value of the volume of the sounds provided by the speaker 130 at every end of the constant time interval and stores the value of the volume of the sounds provided by the speaker 130 when the user finishes using the handheld device 100. The handheld device 100 can use an appropriate value of the volume of the sounds next time the user uses the handheld device 100 so that the user can communicate with others by the handheld device 100 comfortably.

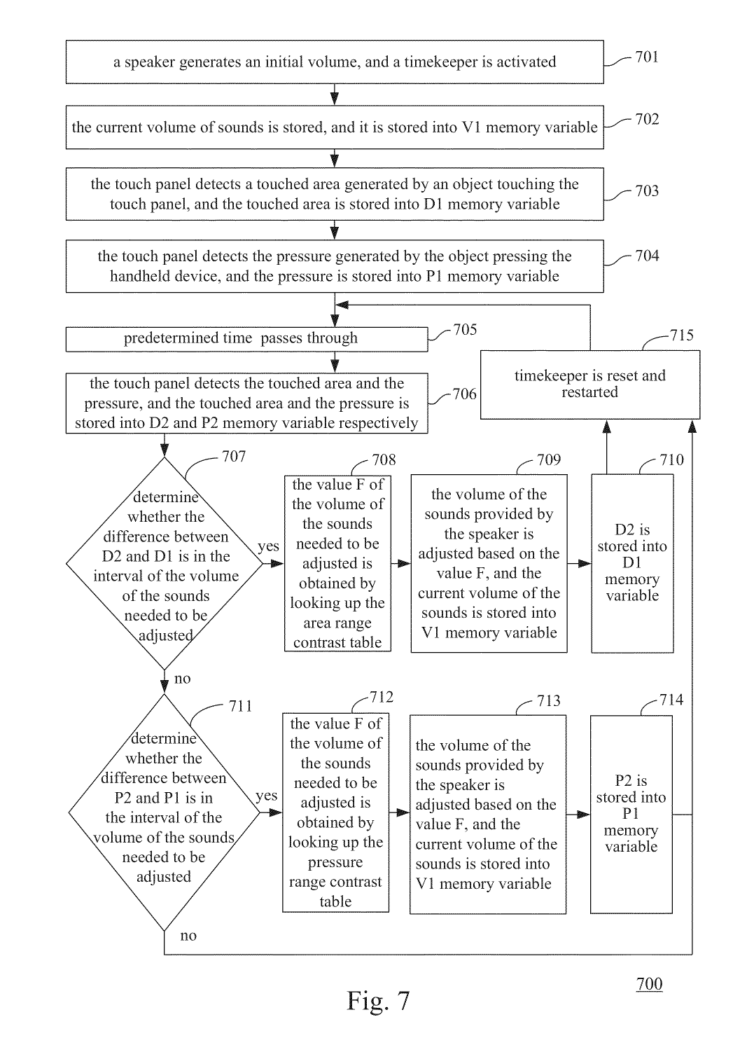

FIG. 7 schematically shows a waveform diagram of a method 700 for controlling a handheld device according to embodiments of the present invention. In the embodiment of the present invention, the method 700 for controlling the handheld device can be separated into an initial condition detecting stage, a using condition detecting stage, and a volume of the sounds adjusting stage. However, the present invention is not intended to be limited in this regard, and the separations of the method 700 for controlling the handheld device as mentioned above is merely for interpretation and make it easier to be understood.

Reference is now made to both FIG. 1 and FIG. 7. In the initial condition detecting stage, the speaker 130 generates an initial volume, and a timekeeper is activated (step 701). Next, the current volume of sounds is stored, and it is stored into V1 memory variable (step 702). Then, the touch panel 110 detects a touched area generated by an object touching the touch panel 110, and the touched area is stored into D1 memory variable (step 703); meanwhile, the touch panel 110 detects the pressure generated by the object pressing the handheld device 100, and the pressure is stored into P1 memory variable (step 704). The steps as described above is used to detect every value of the initial condition, and the values of the initial condition can be used to calculate the volume of the sounds at the subsequent steps.

In the using condition detecting stage, when a predetermined time which is counted from the beginning of the timekeeper being activated passes through (step 705), the touch panel 110 detects the touched area generated by an is object touching the touch panel 110 and the pressure generated by the object pressing the handheld device, and the touched area and the pressure is stored into D2 and P2 memory variable respectively (step 706). The predetermined time can be set based on actual requirements, for instant, but not limited to 500 milliseconds. The steps as described above are used to detect the value of the using condition, and the values of the using condition can be used to calculate the volume of the sounds at the subsequent steps.

In the volume of the sounds adjusting stage, referring to both FIG. 4 and FIG. 7, the processor 120 can be implemented to determine whether the difference between D2 and D1 is in the interval of the volume of the sounds needed to be adjusted (step 707). The interval of the volume of the sounds needed to be adjusted is illustrated as the first interval (10˜19) to the sixth interval (−30˜−39) of FIG. 4 but not include the middle interval (−9˜−9). If it is determined that the difference between D2 and D1 is in the interval of the volume of the sounds needed to be adjusted, the value F is obtained by looking up the area range contrast table (step 708). Then, the volume of the sounds provided by the speaker 130 is adjusted based on the value F, and the current volume of the sounds is stored into V1 memory variable (step 709). Furthermore, D2 is stored into D1 memory variable (step 710).

Refering to step 707, if it is determined that the difference between D2 and D1 is not in the interval of the volume of the sounds needed to be adjusted, the is step 711 is implemented to determine whether the difference between P2 and P1 is in the interval of the volume of the sounds needed to be adjusted. The interval of the volume of the sounds needed to be adjusted is illustrated as the first interval (10˜19) to the sixth interval (−30˜−39) of FIG. 5 but not include the middle interval (−9˜+9). If it is determined that the difference between P2 and P1 is in the interval of the volume of the sounds needed to be adjusted, the value F is obtained by looking up the pressure range contrast table (step 712). Then, the volume of the sounds provided by the speaker 130 is adjusted based on the value F, and the current volume of the sounds is stored into V1 memory variable (step 713). Furthermore, P2 is stored into P1 memory variable (step 714).

After the using condition detecting stage and the volume of the sounds adjusting stage are implemented, the timekeeper is reset and restarted in step 715. Next, the method 700 proceeds to step 705 for continually detecting the using condition, and the volume of the sounds provided by the speaker 130 is adjusted based on the detected result of the using condition.

Those having skill in the art will appreciate that the method for controlling the handheld device can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method for controlling the handheld device named after the function thereof is merely used to describe the technology in the embodiment of the present invention in detail but not limited to. Therefore, combining the steps of said method into one step, dividing the steps into several steps, or rearranging the order of the steps is within the scope of the embodiment in the present invention.

In view of the foregoing embodiments of the present invention, many advantages of the present invention are now apparent. The embodiment of the present invention provides a handheld device and a method for controlling thereof is provided, which addresses the problem of adjusting mode of a conventional handheld device being not instinctive due to the adjusting mode of volume of sounds needed to be learned, and which addresses the problem of the adjusting mode of a conventional handheld device being not convenient due to a user having to use the button disposed on the lateral side of the handheld device to adjust the volume of sounds by hand.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A handheld device, comprising:
a touch panel for detecting a touched area generated by an object touching the touch panel;
a speaker for providing sounds; and
a processor electrically connected to the touch panel and the speaker, wherein the processor controls the volume of the sounds provided by the speaker based on the touched area,
wherein the processor decreases the volume of the sounds provided by the speaker when the value of the touched area is lower than a first predetermined value, and the processor increases the volume of the sounds provided by the speaker when the value of the touched area is higher than a second predetermined value.

2. The handheld device according to claim 1, further comprising:
a pressure sensor for sensing a pressure generated by the object pressing the handheld device, wherein the processor is electrically connected to the pressure sensor, and the processor controls the volume of the sounds provided by the speaker based on the pressure, wherein the processor increases the volume of the sounds provided by the speaker when the value of the pressure is higher than a third predetermined value.

3. The handheld device according to claim 2, wherein the pressure sensor is activated when the value of the touched area is steady; meanwhile, the processor controls the volume of the sounds provided by the speaker based on the pressure.

4. The handheld device according to claim 1, wherein the touch panel comprises at least one of a resistive touch panel and a capacitive touch panel.

5. The handheld device according to claim 1, wherein the touch panel detects the touched area generated by the object touching the touch panel every constant time interval, the touched area detected at the beginning of the constant time interval is a first touched area, and the touched area detected at the end of the constant time interval is a second touched area, wherein the processor increases the volume of the sounds provided by the speaker when the difference between the second touched area and the first touched area is higher than a range, and the processor decreases the volume of the sounds provided by the speaker when the difference between the second touched area and the first touched area is lower than the negative range.

6. The handheld device according to claim 2, wherein the pressure sensor senses a pressure generated by the object pressing the handheld device every constant time interval, the pressure sensed at the beginning of the constant time interval is a first pressure, and the pressure sensed at the end of the constant time interval is the second pressure, wherein the processor increases the volume of the sounds provided by the speaker when the difference between the second pressure and the first pressure is higher than a range, and the processor decreases the volume of the sounds provided by the speaker when the difference between the second pressure and the first pressure is lower than the negative range.

7. The handheld device according to claim 1, further comprising:
a memory for storing the volume of the sounds provided by the speaker.

8. A method for controlling a handheld device, comprising:
detecting a touched area generated by an object touching a touch panel;
determining whether the value of the touched area is lower than a first predetermined value,
if it being determined that the value of the touched area is lower than the first predetermined value, decreasing a volume of sounds provided by a speaker; and
determining whether the value of the touched area is higher than a second predetermined value,
if it being determined that the value of the touched area is higher than the second predetermined value, increasing the volume of the sounds provided by the speaker.

9. The method for controlling the handheld device according to claim 8, further comprising:
sensing a pressure generated by the object pressing the handheld device; and
determining whether the value of the pressure is higher than a third predetermined value,
if it being determined that the value of the pressure is higher than the third predetermined value, increasing the volume of the sounds provided by the speaker.

10. The method for controlling the handheld device according to claim 9, wherein the step of sensing the pressure generated by the object pressing the handheld device is implemented after the value of the touched area is steady.

11. The method for controlling the handheld device according to claim 8, wherein the step of detecting the touched area generated by the object touching the touch panel is implemented every constant time interval, the touched area detected at the beginning of the constant time interval is a first touched area, and the touched area detected at the end of the constant time interval is a second touched area, wherein the volume of the sounds provided by the speaker is increased when the difference between the second touched area and the first touched area is higher than a range, and the volume of the sounds provided by the speaker is decreased when the difference between the second touched area and the first touched area is lower than the negative range.

12. The method for controlling the handheld device according to claim 9, wherein the step of sensing the pressure generated by the object pressing the handheld device is implemented every constant time interval, the pressure sensed at the beginning of the constant time interval is a first pressure, and the pressure sensed at the end of the constant time interval is a second pressure, wherein the volume of the sounds provided by the speaker is increased when the difference between the second pressure and the first pressure is higher than a range, and the volume of the sounds provided by the speaker is decreased when the difference between the second pressure and the first pressure is lower than the negative range.

13. The method for controlling the handheld device according to claim 8, wherein before the step of detecting the touched area generated by the object touching the touch panel, the method for controlling the handheld device further comprises generating an initial volume of the sounds by the speaker.

14. The method for controlling the handheld device according to claim 13, wherein after the step of decreasing the volume of the sounds provided by the speaker or increasing the volume of the sounds provided by the speaker, the method for controlling the handheld device further comprises storing the volume of the sounds provided by the speaker as the initial volume of the sounds.
